(19) United States
(12) Patent Application Publication
(10) Pub. No.: US 2005/0053793 A1
(43) Pub. Date: Mar. 10, 2005

(54) Liquid silicone formulation for producing release and water-repellent crosslinked elastomer coatings on a solid support, such as a paper support

(76) Inventors: Jean-Paul Benay-Oun, Lyon (FR); Didier Dhaler, Tassin la Demi Lune (FR); Jacques Keiffer, Neyron (FR); Frederic Magd, Lyon (FR); John White, Chessy Les Mines (FR)

Correspondence Address: BURNS DOANE SWECKER & MATHIS L L P, POST OFFICE BOX 1404, ALEXANDRIA, VA, 22313-1404, US

(21) Appl. No.: 10/493,577

(22) PCT Filed: Oct. 24, 2002
(86) PCT No.: PCT/FR02/03654

(30) Foreign Application Priority Data
Oct. 26, 2001 (FR) 01/13915

(51) Int. Cl. B32B 9/04; C08L 83/04

(52) U.S. Cl. 428/447; 528/32; 528/33; 528/34

(57) ABSTRACT

The invention relates to a liquid silicone formulation for the preparation of water-repellent and release crosslinked elastomer coatings on a solid support, for example made of paper. The targeted aim is to overcome the problem of the lack of adhesion of silicone elastomer films with a release outer face intended to be adhesively bonded to flexible supports of the following types: dense paper of glassine type or polypropylene polymer film. To achieve this aim, the liquid silicone formulation according to the invention which can be used as coating base for the preparation at very high speed of a water-repellent and release crosslinked elastomer coating on a solid support comprises: at least one crosslinkable polyorganosiloxane POS (I) (POS of SiVi type and POS of SiH type); at least one catalyst (II) (platinum-based); optionally an adhesion-adjusting system (III);
an adhesion promoter (IV) comprising an epoxidized alkoxysilane and/or an alkenylated alkoxysilane, and a metal chelate and/or a metal alkoxide (GLYMO/MEMO/TiOBu₄). The most viscous POS (I) has a viscosity of less than or equal to 1500 mPa·s.

The field of the invention is that of water-repellent and release coatings for flexible supports, for example made of paper or of polymer film. The release coatings under consideration are more specially those based on a silicone elastomer crosslinked in situ, that is to say after coating noncrosslinked liquid silicone formulations on solid supports, for example made of paper or of polymer film.

In particular, the release silicone coatings with which the present account is concerned are those comprising one or more polyorganosiloxanes (POS) which can be crosslinked by polyaddition (Si—H POS/Si-Vinyl POS), by polycondensation, by cationic or radical polymerization, under thermal and/or actinic activation and/or activation by means of an electron beam.

In these release applications, for example on paper or on polymer film, the liquid silicone coating formulations comprise, in addition to the silicone polymers, a polycondensation or polyaddition catalyst or a cationic or radical initiator, and at least one adhesion-adjusting system, for example based on silicone resin comprising Q siloxyl units (SiO_{4/2}) and/or T siloxyl units (RSiO_{3/2}).

These liquid silicone formulations are applied to support films in industrial coating devices comprising rolls operating at a very high speed (600 m/min).

Naturally, it is obvious that, in these very high-speed coating procedures, the viscosity of the liquid silicone coating formulation must be precisely adapted to the coating operating conditions.

In these liquid silicone coating formulations, the silicone phase can be diluted in a solvent. According to a more advantageous alternative form, in particular for reasons of health and safety, the liquid silicone formulation is an aqueous dispersion/emulsion.

Once applied to the support film, the silicone formulation crosslinks to form a firm, water-repellent and/or release, coating made of silicone elastomer.

In view of the very high-speed industrial coating rates, the kinetics of crosslinking have to be instantaneous.

If the first function of such a silicone coating is the ability to release of its outer face, it does nonetheless remain the case that the coating has to be attached, by its inner face, to the flexible solid support with very strong adhesion.

The ability to release of the outer face of the silicone coating is expressed through the detachment force, which has to be weak and controlled, for the element intended to be positioned on the support coated by the release silicone film. Conventionally, this element can be the adhesive face of a label or of a tape of the same kind.

Thus, in addition to this weak and controlled detachment force, the adhesion of the silicone coating to its support has to be very high. This property of adhesion is assessed, for example, using the rub off trade test, which consists in rubbing the surface of the coating with a finger and in measuring the number of successive passes which result in damage to the coating.

The solid supports coated with a release silicone film can be, for example:
an adhesive tape, the inner face of which is coated with a layer of pressure-sensitive adhesive and the outer face of which comprises the release silicone coating;
or a paper or a polymer film for protecting the adhesive face of a self-adhesive element or pressure-sensitive adhesive, it being possible for this element to be a paper or a polymer film of the poly(vinyl chloride) (PVC), PolyEster, PolyPropylene or Poly(Ethylene Terephthalate) type, the nonadhesive face of this element generally being printed or printable so as to be able to act as label capable of being detached from its support and stuck by simple pressing to an article to be identified.

In practice, the degree of deposition of release silicone is between 0.1 and 1, preferably 0.3 and 0.5 g/m², which corresponds to thicknesses of the order of a micrometre.

In point of fact, in the state of the art, it is known that, on certain supports, such as very dense glassine-type paper or such as polymer films of PE or of PP, for example, the adhesion characteristics of crosslinked silicone films are mediocre (low number of successive passes in the rub off tests).

These poor adhesion characteristics are further accentuated if the coating/crosslinking speeds of the liquid silicone formulation increase.

Paper of glassine type with a grammage of 60-65 g/m² is paper manufactured from a highly refined bisulphite pulp which results in high entangling of the fibres and which contributes to “densifying” the paper. The two faces of the glassine paper are coated with a layer based on poly(vinyl) alcohol and on carboxymethyl cellulose. The paper is subsequently calendered to give it a degree of transparency.

Various prior technical proposals have come to light in attempting to control this problem of the adhesion of a silicone coating exhibiting a release outer face to supports such as very dense glassine-type paper or polymer films of polyester or polypropylene type.

Thus, a Dow Corning/Dow Corning-Toray patent dating from 1971 (U.S. Pat. No. 3,691,206) discloses the use of a mixture of acetoxysilane and of 3-GLYcidoxypropyltriMethOxysilane (GLYMO) for improving the attachment to paper supports of silicone elastomer coatings which crosslink by condensation. The adhesion performances obtained using this acetoxysilane+GLYMO promoter remain, however, capable of improvement.

European Patent EP-B-0 272 809 relates to an adhesion promoter intended to be incorporated in POS compositions which can be crosslinked by the radical route under actinic activation (UV) or by exposure to an electron beam. This adhesion promoter is based on a mixture of alkoxylated silane, such as, for example: vinyltrimethoxysilane/(N-β-aminoethyl)-γ-aminopropyl)trimethoxysilane. It is in fact a question of a cohydrolysis of these 2 alkoxysilanes, which condense to form copolymers. Such an adhesion promoter is added to a silicone composition based on POS which can be crosslinked by the radical route under UV radiation or under an electron beam (polydimethylsiloxane/γ-mercaptopropylmethylsiloxane copolymer comprising trimethylsiloxy ends), at the rate of 0.1 to 30 parts by weight of promoter per 100 parts by weight of POS. It is shown in the examples of this European patent that the claimed promoter based on the vinyltrimethoxysilane/(N-(β-aminoethyl)-γ-aminopropyl)-trimethoxysilane mixture gives better results in terms of adhesion (rub off) than the compounds of the mixture taken separately. Nevertheless, this patent does not prove a significant improvement in the adhesion properties.

French Patent Application FR-A-2 469 435 discloses adhesion promoters based on alkoxysilane (methyltrimethoxysilane/γ-(aminoethyl)-aminopropyl-trimethoxysilane) as a mixture with a catalyst of dibutyltin diacetate type. Such an adhesion promoter is used in combination with POS compositions in which the POS carries OH and/or OR groups which can be crosslinked by polycondensation. This adhesion promoter does not appear to be particularly effective.

Furthermore, in another field than that of the ability to release of paper, French Patent FR-B-2 719 598 discloses silicone elastomer coating compositions of room temperature vulcanizable RTV type comprising at least one Si-Vi POS, at least one Si—H POS, a platinum catalyst, an adhesion promoter, optionally an inorganic filler, optionally a crosslinking inhibitor and optionally a POS resin. The adhesion promoter comprises:
vinyltrimethoxysilane (VTMS),
3-GLYcidoxypropyltriMethOxysilane (GLYMO),
and butyl titanate.

In these silicone compositions which can be crosslinked at ambient temperature by polyaddition, the silicone phase exhibits an overall dynamic viscosity at 25° C. of greater than 3000 mPa·s. In practice, the Si-Vi oils employed have a viscosity of 100 000 mPa·s and of 10 000 mPa·s respectively, whereas the viscosity of the Si—H POS oil is of the order of 300 mPa·s.

Furthermore, these silicone compositions which can be crosslinked at ambient temperature by polyaddition are intended to be applied to preferably fibrous supports and more preferably still to textile supports made of synthetic fibres of the polyester or polyamide type. A common use of these crosslinkable silicone compositions is the coating of airbags intended for the protection of a vehicle occupant.

In view of its very high viscosity, the silicone composition according to FR-B-2 719 598 cannot truly be regarded as altogether liquid.

In addition, the adhesion promoter which it comprises necessarily comprises 3 constituents: alkoxylated and alkenylated silane (vinyltrimethoxy-silane)/alkoxylated and epoxidized silane (GLYMO)/metal chelate (butyl titanate).

Furthermore, it should be noted that, in the silicone elastomer coating applications on textiles for the purposes of mechanical strengthening, the industrial coating rates are in no way comparable with the coating rates for release silicone coating on supports made of paper or of polymer film: 10-20 m/min versus 600 m/min. In the same way, the thickness of the films deposited on the two applications is completely different: 20-30 μm versus 1 μm.

In fact, in textile coating applications, silicone compositions comprising long silicone oils of high viscosity are employed, whereas, in liquid silicone formulations for paper or polymer film release coating, the POSs employed are short POSs of low viscosity.

Furthermore, liquid silicone formulations for release coating on a support made of paper or of polymer film comprising adhesion promoters based on vinylated acetoxysilane (Vi-Si(OCH₃)₃) and on GLYMO are available on the market. However, such promoters are not satisfactory with regard to the adhesion of release silicone films to specific supports of the following types: dense paper (glassine) or polymer film of polypropylene type.

It is therefore necessary to observe that the prior technical proposals do not introduce satisfactory solutions to the problem of the lack of adhesion of silicone elastomer films with a nonadhesive outer face which are intended to be adhesively bonded to flexible supports of the following types: dense paper of glassine type or polymer film of polypropylene type.

One of the essential objectives of the present invention is to provide a liquid silicone formulation which can be used as coating base for the preparation, at a very high speed, of a water-repellent and release crosslinking elastomer coating on a solid support, the said formulation making possible excellent attachment of the coating to the support, while exhibiting all the characteristics of release and/or of hydrophobicity and all the mechanical qualities desired.

Another essential objective of the present invention is to provide a noncrosslinked liquid silicone formulation exhibiting rheological characteristics such that it can be easily applied to the surface of a support film moving at a very high speed, the said formulation, once coated, then being capable of crosslinking to form a cured coating firmly attached to the support by one of its faces and having, on another face, water-repellent and/or release properties and mechanical qualities which are optimal.

Another essential objective of the invention is to provide a liquid silicone formulation which can be used as coating base for the preparation, at very high speed, of release crosslinked elastomer coatings on a solid support of very dense paper (glassine) type or of polyester or polypropylene film type, the said coating being perfectly bonded to the support.

Another essential objective of the present invention is to provide a process for the preparation, at very high speed, of a water-repellent and release crosslinked elastomer coating on a solid support, in which process:
a precoating based on a functionalized POS grafted by units which are intent only on saturating, for example of (meth)acrylate type, is first of all prepared, the said units to be saturated being intended to make possible polymerization of the grafted functionalized POS;
and coating is carried out with an outer layer based on a release silicone elastomer perfectly attached to the precoating based on polymerized grafted functionalized POS.

Another essential objective of the invention is to provide a solid support, for example made of dense paper of glassine type or of polymer film of polypropylene or polyester type, to which would be firmly attached a water-repellent and/or release crosslinked silicone elastomer coating.

These objectives, among others, are achieved by the present invention, which relates first of all to a liquid silicone formulation which can be used as coating base for the preparation, at very high speed, of water-repellent and release crosslinked elastomer coatings on a solid support, this formulation comprising in particular:
at least one silicone composition based on at least one polyorganosiloxane (I) which can be crosslinked by polyaddition, by polycondensation, by the cationic or radical route, under thermal and/or actinic activation and/or activation obtained using an electron beam,
at least one catalyst/initiator (II),
optionally at least one adhesion-adjusting system (III),
   characterized:
in that it also comprises at least one adhesion promoter (IV) based on:
   at least one of the following compounds (IV.1) and (IV.2):
      (IV.1) at least one alkoxysilane comprising at least one epoxy radical,
      (IV.2) at least one alkoxysilane comprising, per molecule, at least one C₂-C₆ alkenyl group,
   and, in addition:
      (IV-3) at least one chelate of the metal M and/or one metal alkoxide of general formula M(OJ)ₙ, where n=valency of M and J=linear or branched C₁-C₈ alkyl, M being chosen from the group formed by: Ti, Zr, Ge, Li, Mn, Fe, Al and Mg;
and in that the POS(s) (I) of higher viscosity has (have) a dynamic viscosity η at 25° C. of less than or equal to 1500 mPa·s.

By employing this specific adhesion promoter (IV) in this liquid silicone formulation of low viscosity, the invention makes possible access to high levels of adhesion of the crosslinked release silicone elastomer coating to various supports. In particular, it is possible, by virtue of the invention, to bring about the adhesion of a water-repellent and/or release crosslinked silicone elastomer coating to supports which are regarded as difficult, such as, for example, poly(ethylene terephthalate) PET films, polyethylene PE films or polypropylene PP films, and highly densified paper, such as glassines.

The formulation according to the invention has the peculiarity that it is liquid, that is to say that it has sufficiently weak characteristics of viscosity for its application to solid supports moving at very high speed to be easy to carry out. In practice, this corresponds to an overall dynamic viscosity at 25° C. of less than or equal to 1000 cPs. This Theological characteristic of the liquid silicone formulation is due in part to the fact that the most viscous POS(s) (I) has (have) a dynamic viscosity η at 25° C. of less than or equal to 1500 mPa·s.

Such a not very viscous liquid nature makes it possible to produce very fine coating thicknesses of the order of a micrometre.

It is to the credit of the inventors to have found that, entirely surprisingly and unexpectedly, the combination of an epoxidized alkoxysilane or of an alkenylated alkoxysilane with a metal chelate and/or alkoxide results in an altogether significant promotion of the adhesion.

In order to further strengthen the beneficial effects of the adhesion promoter according to the invention, it is advantageous to carry out a corona treatment on the supports intended to receive the crosslinked elastomer coating resulting from the formulation according to the invention. This corona treatment is particularly recommended for polymer supports. Corona treatment consists in decomposing the surface of the support by an electrical discharge and creating reaction functional groups which will promote attachment.

According to a preferred characteristic of the invention, the epoxidized alkoxysilane (IV.1) of the promoter (IV) is chosen:
either from the epoxidized alkoxysilanes (IV.1a) of following general formula: 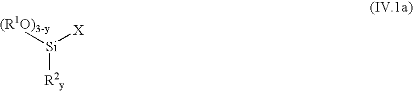
   in which:
   R¹ is a linear or branched C₁-C₄ alkyl radical,
   R² is a linear or branched alkyl radical,
   y is equal to 0, 1, 2 or 3, 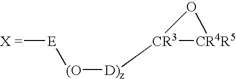
      with
      E and D being identical or different radicals chosen from linear or branched C₁-C₄ alkylenes,
      z being equal to 0 or 1,
      R³, R⁴ and R⁵ being identical or different radicals representing hydrogen or a linear or branched C₁-C₄ alkyl,
      it alternatively being possible for R³ and R⁴ or R⁵ to constitute, together with the two carbon atoms carrying the epoxy, an alkyl ring having from 5 to 7 ring members,
or from the epoxidized alkoxysilanes (IV.1b) composed of epoxyfunctional polydiorganosiloxanes comprising at least one unit of formula:
   XₚG_{q}SiO_{4-(p+q)/2} (IV.1bi)
   in which:
   X is a radical as defined above for the formula (IV.1a),
   G is a monovalent hydrocarbonaceous group which has no unfavourable effect on the activity of the catalyst and which is chosen from alkyl groups having from 1 to 8 carbon atoms inclusive, optionally substituted by at least one halogen atom, and from aryl groups,
   p=1 or 2,
   q=0, 1 or 2,
   p+q=1, 2 or 3,
      optionally, at least a portion of the other units of these polydiorganosiloxanes being units of mean formula:
      G′ᵣSiO_{4-r/2} (IV.1bii)
      in which G′ has the same meaning as that of G given above and r has a value of between 0 and 3.

These compounds (IV.1) are therefore preferably epoxidized alkoxysilanes comprising only a single silicon atom.

As regards the alkenylated alkoxysilanes (IV.2), those corresponding to the following general formula (IV.2) are preferably chosen for participating in the composition of the adhesion promoter according to the invention: 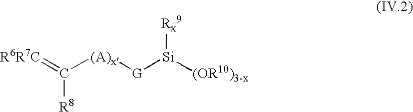
in which:
R⁶, R⁷ and R⁸ are hydrogenated or hydrocarbonaceous radicals which are identical to or different from one another and which represent hydrogen, a linear or branched C₁-C₄ alkyl or a phenyl optionally substituted by at least one C₁-C₃ alkyl,
A is a linear or branched C₁-C₄ alkylene or a divalent group of formula —CO—O-alkylene-, where the alkylene residue is as defined above and the valency—is connected to the Si via G,
G is a valency bond,
R⁹ and R¹⁰ are identical or different radicals and represent a linear or branched C₁-C₄ alkyl,
x′=0 or 1,
x=0 to 2.

As regards the compound (IV.3), it can consist of, or comprise, a metal chelate. The metal M chosen can comprise one or more ligands, such as those derived in particular from a β-diketone, such as, for example, acetylacetone. The compound (IV.3) can also consist of or comprise a metal alkoxide having the formula M(OJ)ₙ defined above, where the alkoxy radicals are, for example, n-propoxy and n-butoxy radicals. It should be noted that, in this formula, one or more alkoxy radicals OJ can be replaced by one or more constituent ligands of a chelate, such as, for example, an acetylacetone ligand.

The preferred compounds (IV.3) are those in which the metal M is chosen from the following list: Ti, Zr, Ge, Li, Mn, Fe, Al and Mg.

It will be specified that titanium is more particularly preferred and more especially still titanium tetrabutoxide or butyl titanate: Ti(OBu)₄.

Concrete examples of compounds (IV.3) which are highly suitable are those in the structure of which the metal M is chosen from the list: Ti, Zr, Ge, Li, Mn, Fe, Al and Mg, and is combined:
as regards a chelate, with ligands of acetylacetonate type,
as regards an alkoxide, with n-propoxy or n-butoxy radicals.

According to a preferred embodiment of the adhesion promoter according to the invention, the composition selected is the following:
(IV.1) 3-glycidoxypropyltrimethoxysilane (GLYMO) and/or 3-glycidoxypropylethoxysilane and/or β-(3,4-epoxycyclohexyl)-ethyltriethoxysilane,
(IV.2) or vinyltrimethoxysilane (VTMO) and/or 3-methacryloxypropyltrimethoxy-silane (MEMO),
(IV.3) and butyl titanate.

At the quantitative level, it should be pointed out that the (IV.1) or (IV.2)/(IV.3) ratio by weight which is selected according to the invention is between 5 and 0.5 and is preferably of the order of 1.

Still at the quantitative level, it may be specified that the adhesion promoter (IV) is present in a proportion of 0.1 to 10% by weight with respect to the combined constituents.

In the liquid silicone formulations according to the invention, it is advantageous to employ at least one adhesion-adjusting system (III) in order to make it possible to control the release properties of the crosslinked silicone coating.

Mention may be made, as illustration of an adhesion-adjusting system in silicone formulations for ability to release of paper or adhesive tape having a polymer support, of European Patent Application EP-A-0 601 938, the content of which is incorporated in its entirety in the present account.

According to an alternative form, the adhesion-adjusting system (III) can be based on:
(A) at least one polyorganosiloxane resin which exists in the solid form in the dry state and which is composed of at least two different types of siloxyl units R₃SiO₁/₂ (M unit) and SiO₂ (Q unit) and/or RSiO₃/₂ (T unit), and optionally of R₂SiO units (D unit), the R radicals being identical or different and representing organic radicals, with a number of (M) units/number of (Q) and/or (T) units ratio of 0.6-1, the number of optional (D) units being from 0.5 to 10 per 100 mol of resin;
(B) and at least one solvent or at least one diluent of the resin (A) or of a mixture of resins (A).

The R radicals mentioned above represent linear or branched C₁-C₆ alkyl, C₅-C₁₂ cycloalkenyl and/or phenyl radicals.

It should be understood that, in the abovementioned resins, a portion of the R radicals are functional groups which are:

in the case of the formulations which crosslink by polyaddition:
(i) C₂-C₁₂ alkenyl groups which are identical or different from one another, (C₃-C₉) alkenyl groups or (C₂-C₄) oxyalkylene groups;
(2i) hydrogen atoms bonded directly to the Si;
(3i) and/or hydroxyl groups bonded directly to the Si; these abovementioned resins comprising at least 0.1 mol %, preferably from 0.5 to 5 mol %, of the functional groups (i), (2i) and/or (3i);

in the case of the formulations which crosslink by polycondensation:
groups of (3i) type,

in the case of formulations which crosslink under radiation:
groups of (2i) type,
and/or (4i) epoxy groups of formula: 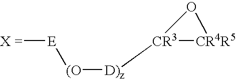
   with
   E and D being identical or different radicals chosen from linear or branched C₁-C₄ alkylenes,
   z being equal to 0 or 1,
   R³, R⁴ and R⁵ being identical or different radicals representing hydrogen or a linear or branched C₁-C₄ alkyl,
   it alternatively being possible for R³ and R⁴ or R⁵ to constitute, together with the two carbon atoms carrying the epoxy, an alkyl ring having from 5 to 7 ring members.

Mention may be made, as examples of resins, of the MQ, MDQ, MDT or MDTQ resins, where the functional groups (i) to (4i) can be carried by the M, D and/or T units.

In practice, the resins which are highly suitable are:
formulations which crosslink by polyaddition:
   MD^{Vi}Q
   MM^{Vi}Q
   MM^{Vi}D^{Vi}Q
   MM^{Vi}DD^{Vi}Q
   MD^{H}Q
   MM^{H}Q
formulations which crosslink by polycondensation:
   M^{OH}Q
formulations which crosslink under radiation:
   MD^{H}Q
   MM^{H}Q

Although the invention is not limited to silicone formulations comprising POSs which can be crosslinked by polyaddition, the silicone composition is preferably a mixture formed of:
(I.1) at least one polyorganosiloxane exhibiting, per molecule, at least two C₂-C₆ alkenyl groups bonded to the silicon,
(I.2) at least one polyorganosiloxane exhibiting, per molecule, at least three hydrogen atoms bonded to the silicon, I.1 and I.2,
   the catalyst (II) being composed of at least one metal belonging to the platinum group,
   this composition and this catalyst (II) being combined with an optional crosslinking inhibitor (V).

More preferably still:
the polyorganosiloxane (I.1) exhibits units of formula:
   TₐZ_{b}SiO_{4-(a+b)/2} (I.1i)
   in which:
   T is an alkenyl group,
   Z is a monovalent hydrocarbonaceous group which has no unfavourable effect on the activity of the catalyst and which is chosen from alkyl groups having from 1 to 8 carbon atoms inclusive, optionally substituted by at least one halogen atom, and from aryl groups,
   a is 1 or 2, b is 0, 1 or 2 and a+b is between 1 and 3,
   optionally at least a portion of the other units being units of mean formula:
      Z_{c}SiO_{4-c/2} (I.1ii)
      in which Z has the same meaning as above and c has a value of between 0 and 3,
the polyorganosiloxane (I.2) comprises siloxyl units of formula:
   H_{d}LₑSiO_{4-(d+e)/2} (I.2i)
   in which:
   L is a monovalent hydrocarbonaceous group which has no unfavourable effect on the activity of the catalyst and which is chosen from alkyl groups having from 1 to 8 carbon atoms inclusive, optionally substituted by at least one halogen atom, and from aryl groups,
   d is 1 or 2, e is 0, 1 or 2 and d+e has a value of between 1 and 3,
   optionally at least a portion of the other units being units of mean formula:
      L_{g}SiO_{4-g/2} (I.2ii)
      in which L has the same meaning as above and g has a value of between 0 and 3.

Advantageously, the proportions of (I.1) and of (I.2) are such that the molar ratio of the hydrogen atoms bonded to the silicon in (I.2) to the alkenyl radicals bonded to the silicon in (I.1) is between 0.4 and 10.

The crosslinking inhibitors (V) capable of being employed are, for example, α-acetylenic alcohols or maleates/fumarates.

According to an alternative form of the invention, the formulation can comprise one or more additives which are conventional in the field of release silicone coatings for a solid support, for example made of paper. They can, for example, be antimisting additives: silica particles, for example.

Although the formulation according to the invention can be an organic solution, it is preferable for it to be provided in the form of an aqueous emulsion/dispersion.

Additives conventional for such emulsion/ dispersions can be employed. Thus, mention may be made, among emulsifying agents which can be used, alone or as a mixture, of conventional anionic agents, such as fatty acid salts, alkyl sulphates, alkylsulphonates, alkylarylsulphonates, sulphosuccinates, alkali metal alkyl phosphates, or salts of hydrogenated or nonhydrogenated abietic acid, or of nonionic agents, such as polyethoxylated fatty alcohols, polyethoxylated and optionally sulphated alkylphenols or polyethoxylated fatty acids. These can be employed in a proportion of 0.1 to 3% by weight with respect to the total weight of the formulation.

According to another of its aspects, the present invention relates to the use of the formulation as defined above as coating base for the preparation, at very high speed, of water-repellent and release crosslinked elastomer coatings on a solid support, preferably chosen:
from sheets made of polymer material or of paper, cardboard or the like,
from adhesive tapes on their nonadhesive face,
from intermediate films of double-sided adhesive tapes,
or from woven or nonwoven and/or composite or noncomposite fibrous supports.

The present invention also relates to the solid support at least partially coated using the formulation as defined above.

As emerges from the above, the silicone formulation according to the invention can be applied directly to the support to be coated or, according to an alternative form, after treatment of the latter using a precoat which makes it possible to reduce the penetration of the release agent or agents into the support and/or to reduce the sensitivity of the support to water, the said precoat being obtained by coating by means of an aqueous emulsion based on a functionalized polyorganosiloxane grafted by unsaturated units, for example of the acrylic type.

Thus, another subject-matter of the present invention is a process for the production, at very high speed, of water-repellent and release crosslinked elastomer coatings on a solid support, characterized in that it consists essentially:
in coating the solid support with a precoating based on grafted functionalized polyorganosiloxanes comprising grafted copolymer units derived from at least one ethylenically unsaturated monomer capable of polymerizing by the radical route and a functionalized polyorganosiloxane (A) comprising alike or different units (A) of following formula (A):
   RₐY_{b}X_{c}SiO_{(4-a-b-c)/2}
   in which formula:
   the R symbols are alike or different and represent a linear or branched C₁-C₁₀ alkyl group, a linear or branched C₂-C₂₀ alkenyl group or a C₆-C₁₂ aryl or aralkyl group, optionally substituted by halogen atoms;
   the X symbols are alike or different and represent an epoxy-functional hydrocarbonaceous group comprising from 2 to 20 carbon atoms which is connected to a silicon atom via an Si—C or Si—O—C bond;
   the Y symbols are alike or different and represent an ethylenically unsaturated hydrocarbonaceous residue which can comprise one or more heteroelement(s) O or N, this residue being bonded to a silicon atom of the unit of formula (A) via an Si—C bond and being capable of reacting via the radical route with the said ethylenically unsaturated monomer(s);
   a, b and c are equal to 0, 1, 2 or 3;
   a+b+c=0, 1, 2 or 3;
      the level of SiO_{4/2} units being less than 30 mol %;
      the number of units of formula (A) in which the silicon atom carries an X functional group and/or a Y residue being such that the said polyorganosiloxanes comprise:
         at least 1 milliequivalent, preferably from 5 to 500 milliequivalents and more preferably still from 5 to 100 milliequivalents of X functional groups per 100 grams of polyorganosiloxane of formula (A),
         at least 5 milliequivalents, preferably from 10 to 500 milliequivalents, of Y residues per 100 grams of polyorganosiloxane of formula (A),
and in then coating this precoating using the formulation according to any one of claims 1 to 13, so as to obtain a water-repellent and release crosslinked elastomer coating.

As disclosed in PCT Application WO 01/04418, the grafted functionalized polyorganosiloxane composing the precoat can be combined with a polymer material of acrylic type. For further details, reference may be made to PCT WO 01/04418.

Advantageously, the liquid silicone formulation according to the invention makes it possible to produce, on a solid support comprising the precoat targeted in the process defined above and in PCT Application WO 01/04418, a release silicone coating.

Finally, the present invention relates to a solid support at least partially coated using the formulation as defined above or obtained by the process in which a layer of a primer precoat is produced, the said solid support being characterized in that it is intended for adhesive labels.

The nonlimiting examples which follow will make it possible to achieve a better understanding of the invention and to grasp therefrom all its advantages and alternative embodiments.

### EXAMPLES

### Example 1

### Adhesion to a Paper Support

Coating/polymerization conditions on a Rotomec pilot-scale coating plant.
1st oven: 180° C./2nd oven: 200° C./3rd oven: 220° C.
Speed: 100 m/min
Deposition: 0.5 to 0.8 g/m² with and without corona treatment
Support: “Century 65” glassine paper from MACtac.

The corona treatment can be defined as follows: Sherman Treater GX10 device adjusted to a power of 1 kW for a machine width of 400 mm.

The constituents of the liquid silicone formulations tested are chosen from the group consisting of:
(a) Poly 1=oil vinylated at the chain end and middle, α,ω-bis(vinyldimethylsiloxy)poly-(dimethyl)(methylvinyl)siloxane, viscosity 235 cPs, level of Vi 0.033 mol/100 g,
   Poly 2=oil vinylated at the chain end and middle, α,ω-bis(vinyldimethylsiloxy)poly(dimethyl)(methylvinyl)siloxane, viscosity 500 cPs, level of Vi 0.081 mol/100 g,
   Poly 3=SiH oil homopolymer, α,ω-bis(hydrodimethylsiloxy)poly(dimethyl)(methylhydro)siloxane, viscosity 20 cPs, 1.55 mol of SiH/100 g,
Poly 4=SiH oil copolymer, α,ω-bis(hydrodimethylsiloxy)poly(dimethyl)(methylhydro)siloxane, viscosity 25 cPs, 1.33 mol of SiH/100 g.
(b) Catalyst=3000 ppm solution of Karsted platinum in a vinylated oil, viscosity 300 cPs.
(c) Three attachment promoters are evaluated:

GLYMO (IV.1₁), β-(3,4-epoxycyclohexyl)ethyltriethoxysilane (IV.1₂) (trade name Coatosil 1770 from Witco) and butyl titanate (IV.3). These attachment promoters are used as a mixture. The list of the formulations used is given in Table 1.

TABLE 1

| | Formulations | | | | | | | | | | | | | | | |
|---|---|---|---|---|---|---|---|---|---|---|---|---|---|---|---|---|
| | A | B | C | D | E | F | G | H | I | J | K | L | M | N | O | P |
| Poly 1 | 100 | 100 | — | — | 100 | 100 | — | — | 100 | 100 | — | — | 100 | 100 | — | — |
| Poly 2 | — | — | 100 | 100 | — | — | 100 | 100 | — | — | 100 | 100 | — | — | 100 | 100 |
| Poly 3 | 3.5 | 4.4 | 8.5 | 10.6 | — | — | — | — | — | — | — | — | 4.4 | 4.4 | 10.6 | 10.6 |
| Poly 4 | — | — | — | — | 4.1 | 5.2 | 9.9 | 12.3 | 5.2 | 5.2 | 12.3 | 12.3 | — | — | — | — |
| GLYMO | — | — | — | — | — | — | — | — | 2 | — | 2 | — | 2 | — | 2 | — |
| Coatosil 1770 | — | — | — | — | — | — | — | — | — | 2 | — | 2 | — | 2 | — | 2 |
| Butyl titanate | — | — | — | — | — | — | — | — | 2 | 2 | 2 | 2 | 2 | 2 | 2 | 2 |
| Cata | 3 | 3 | 3 | 3 | 3 | 3 | 3 | 3 | 3 | 3 | 3 | 3 | 3 | 3 | 3 | 3 |
| SiH/SiVi | 1.6 | 2.0 | 1.6 | 2.0 | 1.6 | 2.0 | 1.6 | 2.0 | 2.0 | 2.0 | 2.0 | 2.0 | 2.0 | 2.0 | 2.0 | 2.0 |

The formulations A to H are control formulations.

The formulations I to P are in accordance with the invention.

Some of these formulations are evaluated using the following tests:
Smear test (trace with the finger): evaluation of the level of crosslinking of the coating by describing the oily nature of the surface A, B, C or D.
Migration/Dewetting: a thin line of Shearman ink with a surface tension of 31 mJ/m² is deposited on an adhesive which has been in contact with the silicone coating and the time taken by this ink to dewet and form droplets is monitored. This time is expressed in seconds.
Migration/Test with Scotch tape: Detachment force: the test used corresponds to the Finat standards No. 3 and 10 of edition No. 5 of 1999. This test is carried out 4 days after the crosslinking (off line) with adhesive tapes sold under the Tesa® 7475 trade mark at 23° C. (acrylic base) and Tesa® 7476 trade mark at 70° C. (rubber base).
Rub off attachment: the coating is rubbed with the index finger in order to determine the number of passes necessary to abrade the coating.

The coating conditions, the types of formulations tested and the results of the tests are given in Table 2 below.

TABLE 2
Coating conditions/type of formulation and results of the evaluations

| | | | | | | | Smear | | | | |
|---|---|---|---|---|---|---|---|---|---|---|---|
| | | | | | | | trace | | Migration | | |
| | | Temperature | | | Oxford | | with a | Migration | Test with | Rub off | |
| | | of | Machine | Metering | silicone | Sheet | finger | Dewetting | Scotch tape | Attachment | |
| | Formulation | the ovens | speed | roll | deposition | temperature | (A, B, | (1 to | (yes, | (1 to | Comments/ |
| Test | No. | ° C. | m/min | speed % | g/m² | ° C. | C, D) | 10) | limit, no) | 10) | remarks |
| 1 | B | 180/20/220 | 100 | 10 | 0.60 | 177 | A | 10 | No | 10 | |
| 2 | B | 180/20/220 | 100 | 10 | 0.52 | 177 | A | 10 | No | 10 | Corona |
| 3 | F | 180/20/220 | 100 | 10 | 0.58 | 179 | A | 10 | No | 10 | |
| 4 | F | 180/20/220 | 100 | 10 | 0.62 | 179 | A | 10 | No | 10 | Corona |
| 5 | D | 180/20/220 | 100 | 7 | 0.41 | 179 | A | 10 | No | 10 | |
| 6 | D | 180/20/220 | 100 | 7 | 0.41 | 179 | A | 10 | No | 10 | Corona |
| 7 | H | 180/20/220 | 100 | 7.6 | 0.63 | 179 | A | 10 | No | 10 | |
| 8 | H | 180/20/220 | 100 | 7.6 | 0.66 | 179 | A | 10 | No | 10 | Corona |
| 9 | I | 180/20/220 | 100 | 10.3 | 0.52 | 179 | A | 10 | No | 10 | |
| 10 | I | 180/20/220 | 100 | 10.3 | 0.61 | 179 | A | 10 | No | 10 | Corona |
| 11 | J | 180/20/220 | 100 | 10.5 | 0.62 | 179 | A | 10 | No | 10 | |
| 12 | J | 180/20/220 | 100 | 10.5 | 0.55 | 179 | A | 10 | No | 10 | Corona |
| 13 | M | 180/20/220 | 100 | 10.5 | 0.60 | 179 | A | 10 | No | 10 | |
| 14 | M | 180/20/220 | 100 | 10.5 | 0.50 | 179 | A | 10 | No | 10 | Corona |
| 15 | N | 180/20/220 | 100 | 10.5 | 0.57 | 179 | A | 10 | No | 10 | |
| 16 | N | 180/20/220 | 100 | 10.5 | 0.62 | 179 | A | 10 | No | 10 | Corona |
| 17 | K | 180/20/220 | 100 | 7.6 | 0.49 | 179 | A | 10 | No | 10 | |
| 18 | K | 180/20/220 | 100 | 7.6 | 0.45 | 179 | A | 10 | No | 10 | Corona |
| 19 | L | 180/20/220 | 100 | 7.8 | 0.46 | 179 | A | 10 | No | 10 | |
| 20 | L | 180/20/220 | 100 | 7.8 | 0.43 | 179 | A | 10 | No | 10 | Corona |
| 21 | O | 180/20/220 | 100 | 8.2 | 0.48 | 179 | A | 10 | No | 10 | |
| 22 | O | 180/20/220 | 100 | 8.2 | 0.62 | 179 | A | 10 | No | 10 | Corona |
| 23 | P | 180/20/220 | 100 | 8.2 | 0.51 | 179 | A | 10 | No | 10 | |
| 24 | P | 180/20/220 | 100 | 8.2 | 0.53 | 179 | A | 10 | No | 10 | Corona |
| 25 | A | 180/20/220 | 100 | 10.5 | 0.76 | 179 | A | 10 | No | 10 | |
| 26 | A | 180/20/220 | 100 | 10.5 | 0.57 | 179 | A | 10 | No | 10 | Corona |
| 27 | E | 180/20/220 | 100 | 10.5 | 0.67 | 179 | A | 10 | No | 10 | |
| 28 | E | 180/20/220 | 100 | 10.5 | 0.66 | 179 | A | 10 | No | 10 | Corona |
| 29 | C | 180/20/220 | 100 | 7.6 | 0.44 | 179 | A | 10 | No | 10 | |
| 30 | C | 180/20/220 | 100 | 7.6 | 0.42 | 179 | A | 10 | No | 10 | Corona |
| 31 | G | 180/20/220 | 100 | 7.9 | 0.64 | 179 | A | 10 | No | 10 | |
| 32 | G | 180/20/220 | 100 | 7.9 | 0.58 | 179 | A | 10 | No | 10 | Corona |

The performance in the rub off test (0 poor/10 excellent) is evaluated either after stoving for 15 days in an oven at 90% RH and 50° C. or after application of adhesive. These tests make it possible to simulate natural ageing of the complex. All the results obtained are combined in Tables 3, 4, 5 and 6.

TABLE 3
Results of the evaluations in the rub off test: test with attachment promoters without corona treatment

| | Test | | | | | | | |
|---|---|---|---|---|---|---|---|---|
| | 9′ | 11′ | 13′ | 15′ | 17′ | 19′ | 21′ | 23′ |
| Additives | GLYMO | Coatosil | GLYMO | Coatosil | GLYMO | Coatosil | GLYMO | Coatosil |
| | Ti(OBu)₄ | 1770 | Ti(OBu)₄ | 1770 | Ti(OBu)₄ | 1770 | Ti(OBu)₄ | 1770 |
| | | Ti(OBu)₄ | | Ti(OBu)₄ | | Ti(OBu)₄ | | Ti(OBu)₄ |
| Rub off after 15 days in an | 10 | 10 | 10 | 10 | 10 | 10 | 10 | 10 |
| oven at 90% RH and 50° C. | | | | | | | | |
| Rub off after application of adhe- | 10 | 10 | 10 | 10 | 10 | 10 | 10 | 10 |
| sive | | | | | | | | |
| | Test | | | | | | | |
| | 10 | 12 | 14 | 16 | 18 | 20 | 22 | 24 |
| Silicone composition | 11367/98 M | 11367/98 M | 11367/96 A | 11367/96 A | 11384/98 M | 11384/98 M | 11384/96 A | 11384/96 A |
| Additives | GLYMO | Coatosil | GLYMO | Coatosil | GLYMO | Coatosil | GLYMO | Coatosil |
| | Ti(OBu)₄ | 1770 | Ti(OBu)₄ | 1770 | Ti(OBu)₄ | 1770 | Ti(OBu)₄ | 1770 |
| | | Ti(OBu)₄ | | Ti(OBu)₄ | | Ti(OBu)₄ | | Ti(OBu)₄ |
| *Rub off after 15 days in an | 10 | 10 | 10 | 10 | 10 | 10 | 10 | 10 |
| oven at 90% RH and 50° C. | | | | | | | | |
| *Rub off after application of | 10 | 10 | 10 | 10 | 10 | 10 | 10 | 10 |
| adhesive | | | | | | | | |

*The rub off is also monitored after application of adhesive with an aqueous phase acrylic adhesive.

TABLE 4
Results of the rub off test: test without attachment promoter without corona treatment

| | Test | | | | | | | |
|---|---|---|---|---|---|---|---|---|
| | 27′ | 3′ | 25′ | 1′ | 31′ | 7′ | 29′ | 5′ |
| Silicone | Formulation E | Formulation F | Formulation A | Formulation B | Formulation G | Formulation H | Formulation C | Formulation D |
| composition | (SiH/SiVi = | (SiH/SiVi = | (SiH/SiVi = | (SiH/SiVi = | (SiH/SiVi = | (SiH/SiVi = | (SiH/SiVi = | (SiH/SiVi = 2.0) |
| | 1.6) | 2.0) | 1.6) | 2.0) | 1.6) | 2.0) | 1.6) | |
| Rub off | 0 | 0 | 0 | 0 | 0 | 0 | 0 | 0 |
| after 15 | | | | | | | | |
| days in | | | | | | | | |
| an oven | | | | | | | | |
| at 90% RH | | | | | | | | |
| and 50° C. | | | | | | | | |
| Rub off | 0 | 0 | 0 | 0 | 0 | 0 | 0 | 0 |
| after | | | | | | | | |
| application | | | | | | | | |
| of | | | | | | | | |
| adhesive | | | | | | | | |

TABLE 5
Results of the rub off test: test without attachment promoters with corona treatment

| | Test | | | | | | | |
|---|---|---|---|---|---|---|---|---|
| | 28′ | 4′ | 26′ | 2′ | 32′ | 8′ | 30′ | 6′ |
| Rub off after 15 days in an oven at 90% RH and 50° C. | 0 | 0 | 0 | 0 | 0 | 0 | 0 | 0 |
| Rub off after application of adhesive | 0 | 0 | 0 | 0 | 0 | 0 | 0 | 0 |

The formulations not in accordance with the invention have a very poor resistance to the rub off test. All the formulations according to the invention, to which promoter (IV) has been added, are good. Moreover, they do not impact on the other performances of the coating: release (detachment), polymerization.

### Example 2

### Evaluation of the Additives on a PET Support

The support tested is a biaxially drawn PET film, ref. 6001, from Toray. This film is not corona treated. The list of the formulations evaluated is combined in Tables 6 and 7. It should be remembered that a result of 10 in the rub off test is excellent, whereas a result of 0 is poor. The rub off is measured immediately after coating/crosslinking, and after a certain ageing time.
Coating/crosslinking conditions: Euclid laboratory coatings
Weight of silicone coating: 0.6-0.7 g/m²

Crosslinking in an oven: 150° C./10 s

TABLE 6

Formulations

| | Q | R |
|---|---|---|
| Poly 1 | 100 | 100 |
| Poly 4 | 5.5 | 5.5 |
| MEMO (IV.1₁) | | 4 |
| GLYMO (IV.1₃) | | |
| Butyl titanate (IV.3) | | 4 |
| Catalyst | 6.5 | 6.5 |

Results in the rub off test

| | | |
|---|---|---|
| Rub off, initial | >10 | >10 |
| Rub off, after 24 h | 1 | >10 |

Coating/crosslinking conditions: Euclid laboratory coatings
Weight of silicone coated: 0.7-0.9 g/m²

Crosslinking in an oven: 150° C. and 30 s

TABLE 7

| | Test | | | | | | | |
|---|---|---|---|---|---|---|---|---|
| | S | T | U | V | W | X | Y | Z |
| Poly 1 | 100 | 100 | 100 | 100 | 100 | 100 | | |
| Poly 5 | | | | | | | 100 | 100 |
| Poly 4 | 5.5 | 5.5 | 5.5 | 5.5 | 5.5 | 5.5 | 1.9 | 1.9 |
| TBOT (IV.3) | | 4 | 4 | 3 | 2 | 1 | 2 | |
| MEMO (IV.1₃) | | | 4 | 3 | 2 | 1 | 2 | |
| Catalyst | 6.5 | 6.5 | 6.5 | 6.5 | 6.5 | 6.5 | 4.5 | 4.5 |

Results in the rub off test

| | | | | | | | | |
|---|---|---|---|---|---|---|---|---|
| Rub off, initial | >10 | >10 | >10 | >10 | >10 | >10 | >10 | >10 |
| Rub off, after 24 hours | 2 | >10 | >10 | >10 | 5 | 1 | >10 | >10 |
| Rub off, after 4 days | 1 | >10 | >10 | >10 | 3 | 1 | >10 | 3 |
| 4 days, % silicone removed after the tests: | 81% | 3.5% | 8% | 15% | 30% | 100% | 4% | 20% |
| measurement carried out by X-ray | | | | | | | | |
| fluorescence | | | | | | | | |
| Rub off, after 7 days | Xxx | >10 | >10 | >10 | 2 | xxx | >10 | 1 |
| Rub off, after 3 weeks | Xxx | >10 | >10 | >10 | 3 | xxx | 9 | xxx |
| 3 weeks, % silicone removed after the tests: | 100% | 3.5% | 5% | 10% | 36% | 100% | 7% | 100% |
| measurement carried out by X-ray | | | | | | | | |
| fluorescence | | | | | | | | |

Immediately after coating, the performances in the rub off test are good for all the formulations. After ageing, only the formulations U to Y according to the invention retain a good performance in the rub off test. It is observed that the more additive deployed, the longer lasting the good performance in the rub-off test.

The polymers used are those of Example 1, except:
Poly 5=oil vinylated at the chain end, viscosity 1000 cPs and a level of vinyl of 0.0107 mol/100 g.

### Example 3

### Effect of Different Mixtures of Promoter (IV) According to the Invention with Respect to the Attachment to a Corona-Treated PET Support

Different mixtures of butyl titanate/GLYMO in two release silicone formulations with Poly 1 and Poly 5. The rub off tests are carried out before and after accelerated ageing cycles:
1) Exposure to the air at ambient temperature,
2) Storage in a confined atmosphere at ambient temperature,
3) Exposure to 100% relative humidity.

All the other performances of the coating were evaluated: adjustment, polymerization.

Coating/crosslinking conditions on a Rotomec coating device
Temperature of the 3 ovens: 180° C.,
Machine speed: 80 m/min,
Silicone deposition: 1.0 g/m²,
Power of the corona treatment: 1.0 kWatt, application immediately before silicone-coating,
Support: PET 6001.

The results obtained are given in the following Table 8.

TABLE 8

| | Formulations | | | | | | | | | | | | |
|---|---|---|---|---|---|---|---|---|---|---|---|---|---|
| | | | | | | | | | | | | | F12 |
| | | A11 + | | B11 + | | C11 + | | D11 + | | E11 + | | F11 + | 150 |
| | A1 | corona | B1 | corona | C1 | corona | D1 | corona | E1 | corona | F1 | corona | m/min |
| Poly 1 | 100 | 100 | 100 | 100 | 100 | 100 | 100 | 100 | | | | | |
| Poly 5 | | | | | | | | | 100 | 100 | 100 | 100 | 100 |
| Poly 4 | 5.5 | 5.5 | 5.5 | 5.5 | 5.5 | 5.5 | 5.5 | 5.5 | 1.9 | 1.9 | 1.9 | 1.9 | 1.9 |
| TBOT (IV.3) | | | 2 | 2 | 4 | 4 | 2.5 | 2.5 | | | 2.0 | 2.0 | 2.0 |
| GLYMO (IV.1₁) | | | | | | | 2.5 | 2.5 | | | 2.0 | 2.0 | 2.0 |
| Catalyst | 6.5 | 6.5 | 6.5 | 6.5 | 6.5 | 6.5 | 6.5 | 6.5 | 4.5 | 4.5 | 4.5 | 4.5 | 4.5 |

Results in the rub off test

| | | | | | | | | | | | | | |
|---|---|---|---|---|---|---|---|---|---|---|---|---|---|
| Rub off | 10 | 10 | 1 | 10 | 10 | 10 | 10 | 10 | 10 | 10 | 10 | 10 | 10 |
| Rub off, 24 h (in | 2 | 2 | 1 | 4 | 2 | 10 | 2 | 10 | 10 | 10 | 10 | 10 | 1 |
| contact with the | | | | | | | | | | | | | |
| air) | | | | | | | | | | | | | |
| Rub off, 7 days (in | 1 | 1 | 1 | 2 | 1 | 10 | 1 | 10 | 3 | 1 | 10 | 10 | 1 |
| contact with the | | | | | | | | | | | | | |
| air) | | | | | | | | | | | | | |
| Rub off, 7 days (not | 1 | 1 | 1 | 10 | 1 | 10 | 1 | 10 | 10 | 10 | 10 | 10 | 1 |
| in contact with the | | | | | | | | | | | | | |
| air) | | | | | | | | | | | | | |
| Rub off, 7 days | 1 | 1 | 1 | 1 | 1 | 5 | 1 | 10 | 1 | 1 | 4 | 10 | 1 |
| 100% RH | | | | | | | | | | | | | |

Release properties of the coatings

| | | | | | | | | | | | | | |
|---|---|---|---|---|---|---|---|---|---|---|---|---|---|
| In-line release* | | | | | | | | | | | | | |
| Tesa 4970 | | | | | | | | | | | | | |
| 24 hours at 23° C. | 20.5 | 18.7 | 22.4 | 20.4 | 17.6 | 25.0 | 18.8 | 18.3 | 10.7 | 9.9 | 9.2 | 9.3 | 11.1 |
| 24 hours at 70° C. | 15.0 | 14.0 | 16.2 | 17.7 | 15.2 | 19.4 | 13.4 | 16.0 | 10.5 | 10.2 | 10.0 | 9.6 | 12.0 |
| 7 days at 70° C. | 18.5 | 14.1 | 17.0 | 18.1 | 16.3 | 18.7 | 15.1 | 17.0 | 10.6 | 10.0 | 10.5 | 11.2 | 12.7 |

*In-line release: Detachment test carried out according to the protocol defined above, at the outlet of the coating device.

Whatever the silicone formulation evaluated, a corona treatment does not overcome the absence of the adhesion promoter (IV) characteristic of the formulation according to the invention.

On a PET film, it is necessary to combine the corona treatment with the silicone formulation of the invention to obtain a good performance in the rub off test. It is found that the promoter (IV) which gives the best performance is composed of a 50/50 titanate (IV.3)/GLYMO (IV.1₁) mixture and it has to be added to a level of 5% in the silicone formulation. No impact of the additives, except with 4% of titanate, is recorded with respect to the release performances of the coatings.

1. Liquid silicone formulation which can be used as coating base for the preparation, at very high speed, of water-repellent and release crosslinked elastomer coatings on a solid support, said formulation comprising:
at least one silicone composition based on at least one polyorganosiloxane (I) which can be crosslinked by polyaddition, by polycondensation, by the cationic or radical route, under thermal and/or actinic activation and/or activation obtained using an electron beam,
at least one catalyst/initiator (II),
optionally at least one adhesion-adjusting system (III),
further comprising at least one adhesion promoter (IV) based on:
at least one of the following compounds (IV.1) and (IV.2):
(IV.1) at least one alkoxysilane comprising at least one epoxy radical,
(IV.2) at least one alkoxysilane comprising, per molecule, at least one C₂-C₆ alkenyl group,
and, in addition:
(IV.3) at least one chelate of the metal M and/or one metal alkoxide of general formula M(OJ)ₙ, where n=valency of M and J=linear or branched C₁-C₈ alkyl, M being chosen from the group formed by: Ti, Zr, Ge, Li, Mn, Fe, Al and Mg;
and in that the POS(s) (I) of higher viscosity has (have) a dynamic viscosity η at 25° C .of less than or equal to 1500 mPa·s.

2. Silicone formulation according to claim 1, wherein the epoxidized alkoxysilane (IV.1) of the promoter (IV) is chosen:
either from the epoxidized alkoxysilanes (IV.1a) of following general formula: 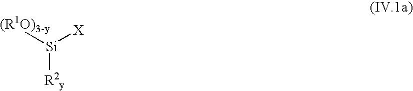
in which:
R¹ is a linear or branched C₁-C₄ alkyl radical,
R² is a linear or branched alkyl radical,
y is equal to 0, 1, 2 or 3, 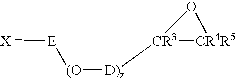
with
E and D being identical or different radicals selected from linear or branched C₁-C₄ alkylenes,
z being equal to 0 or 1,
R³, R⁴ and R⁵ being identical or different radicals representing hydrogen or a linear or branched C₁-C₄ alkyl,
it alternatively being possible for R³ and R⁴ or R⁵ to constitute, together with the two carbon atoms carrying the epoxy, an alkyl ring having from 5 to 7 ring members,
or from the epoxidized alkoxysilanes (IV.1b) composed of comprising epoxyfunctional polydiorgano-siloxanes comprising at least one unit of formula:
XₚG_{q}SiO_{4-(p+q)/2} (IV.1 bi)
in which:
X is a radical as defined above for the formula (IV.1 a),
G is a monovalent hydrocarbonaceous group which has no unfavourable effect on the activity of the catalyst and which is chosen from alkyl groups having from 1 to 8 carbon atoms inclusive, optionally substituted by at least one halogen atom, and from aryl groups,
p=1 or 2,
q=0, 1 or 2,
p+q=1, 2 or 3,
optionally, at least a portion of the other units of these polydiorganosiloxanes being units of means formula:
G′ᵣSiO_{4-r/2} (IV.1bii)
in which G′ has the same meaning as G defined above and r has a value of between 0 and 3.

3. Formulation according to claim 1, wherein the alkenylated alkoxysilane (IV.2) corresponds to the following general formula: 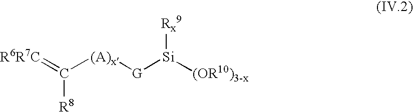
in which:
R⁶, R⁷ and R⁸ are hydrogenated or hydrocarbonaceous radicals which are identical to or different from one another and which represent hydrogen, a linear or branched C₁-C₄ alkyl or a phenyl optionally substituted by at least one C₁-C₃ alkyl,
A is a linear or branched C₁-C₄ alkylene or a divalent group of formula —CO—O-alkylene-, where the alkylene residue is as defined above and the valency—is connected to the Si via G,
G is a valency bond,
R⁹ and R¹⁰ are identical or different radicals and represent a linear or branched C₁-C₄ alkyl,
x′=0 or 1,
x=0 to 2.

4. Formulation according to claim 1, wherein the metal M of the chelate and/or of the alkoxide (IV.3) is chosen selected from the following list: Ti, Zr, Ge, Li or Mn.

5. Formulation according to claim 1, wherein the adhesion promoter comprises:
(IV.1) 3-glycidoxypropyltrimethoxysilane (GLYMO)
and/or 3-glycidoxypropylethoxysilane and/or β-(3,4-epoxycyclohexyl) ethyltriethoxysilane,
(IV.2) or vinyltrimethoxysilane (VTMO) and/or 3-methacryloxypropyltrimethoxy-silane (MEMO),
(IV.3) and butyl titanate.

6. Formulation according to claim 1, wherein the (IV.1) or (IV.2)/(IV.3) ratio by weight is between 5 and 0.5.

7. Formulation according to claim 1, wherein the adhesion promoter (IV) is present in a proportion of 0.1 to 10% by weight with respect to the combined constituents.

8. Formulation according to claim 1, wherein:
in that the composition is a mixture formed of:
(I.1) at least one polyorganosiloxane exhibiting, per molecule, at least two C₂-C₆ alkenyl groups bonded to the silicon,
(I.2) at least one polyorganosiloxane exhibiting, per molecule, at least three hydrogen atoms bonded to the silicon,
in that the catalyst (II) comprises at least one metal belonging to the platinum group,
and in that it comprises:
(V) optionally at least one crosslinking inhibitor.

9. Formulation according to claim 8, wherein the polyorganosiloxane (I.1) exhibits units of formula:
TₐZ_{b}SiO_{4-(a+b)/2} (I.1i)
in which:
T is an alkenyl group,
Z is a monovalent hydrocarbonaceous group which has no unfavourable effect on the activity of the catalyst and which is selected from alkyl groups having from 1 to 8 carbon atoms inclusive, optionally substituted by at least one halogen atom, and from aryl groups,
a is 1 or 2, b is 0, 1 or 2 and a+b is between 1 and 3,
optionally at least a portion of the other units being units of mean formula:
Z_{c}SiO_{4-c/2} (I.1ii)
in which Z has the same meaning as above and c has a value of between 0 and 3.

10. Formulation according to claim 9, wherein the polyorganosiloxane (I.2) comprises siloxyl units of formula:
H_{d}LₑSiO_{4-(d+e)/2} (I.2i)
In which:
L is a monovalent hydrocarbonaceous group which has no unfavourable effect on the activity of the catalyst and which is selected from alkyl groups having from 1 to 8 carbon atoms inclusive, optionally substituted by at least one halogen atom, and from aryl groups,
d is 1 or 2, e is 0, 1 or 2 and d+e has a value of between 1 and 3,
optionally at least a portion of the other units being units of mean formula:
L_{g}SiO_{4-g/2} (I.2ii)
in which L has the same meaning as above and g has a value of between 0 and 3.

11. Formulation according to claim 9, wherein the proportions of (I.1) and of (I.2) are such that the molar ratio of the hydrogen atoms bonded to the silicon in (I.2) to the alkenyl radicals bonded to the silicon in (I.1) is between 0.4 and 10.

12. Formulation according to claim 1, which is provided in the form of an aqueous emulsion/dispersion.

13. A coating base for the preparation, at very high speed, of water-repellent and release crosslinked elastomer coatings on a solid support, comprising the formulation of claim 1 in the form of:
sheets made of polymer material or of paper, cardboard or the like,
adhesive tapes on their nonadhesive face,
intermediate films of double-sided adhesive tapes,
or woven or nonwoven and/or composite or noncomposite fibrous supports.

14. Solid support at least partially coated using the formulation according to claim 1.

15. Process for the production, at very high speed, of water-repellent and release crosslinked elastomer coatings on a solid support, comprising:
coating the solid support with a precoating based on grafted functionalized polyorganosiloxanes comprising grafted copolymer units derived from at least one ethylenically unsaturated monomer capable of polymerizing by the radical route and a functionalized polyorganosiloxane (A) comprising alike or different units (A) of the following formula (A):
RₐY_{b}X_{c}SiO_{(4-a-b-c)/2}
in which formula:
the R symbols are alike or different and represent a linear or branched C₁-C₁₀ alkyl group, a linear or branched C₂-C₂₀ alkenyl group or a C₆-C₁₂ aryl or aralkyl group, optionally substituted by halogen atoms;
the X symbols are alike or different and represent an epoxy-functional hydrocarbonaceous group comprising from 2 to 20 carbon atoms which is connected to a silicon atom via an Si—C or Si—O—C bond;
the Y symbols are alike or different and represent an ethylenically unsaturated hydrocarbonaceous residue which can comprise one or more heteroelement(s) O or N, this residue being bonded to a silicon atom of the unit of formula (A) via an Si—C bond and being capable of reacting via the radical route with the said ethylenically unsaturated monomer(s);
a, b and c are equal to 0, 1, 2 or 3;
a+b+c=0, 1, 2 or 3;
the level of SiO_{4/2} units being less than 30 mol %;
the number of units of formula (A) in which the silicon atom carries an X function group and/or a Y residue being such that the said polyorganosiloxanes comprise:
at least 1 milliequivalent, of X functional groups per 100 grams of polyorganosiloxane of formula (A),
at least 5 milliequivalents, of Y residues per 100 grams of polyorganosiloxane of formula (A),
and coating this precoating using the formulation according to claim 1, so as to obtain a water-repellent and release crosslinked elastomer coating.

16. Solid support at least partially coated using the formulation according to claim 1, which is intended for adhesive labels.
